(19) United States
(12) Patent Application Publication
(10) Pub. No.: US 2007/0182201 A1
(43) Pub. Date: Aug. 9, 2007

(54) STANDOFF BOSS TO CONTROL CRUSH

(75) Inventors: Kevin L. Gilleo, Dexter, MI (US); Shogo Sakai, Ann Arbor, MI (US)

Correspondence Address: GIFFORD, KRASS, SPRINKLE,;ANDERSON & CITKOWSKI, P.C., P.O. BOX 7021, TROY, MI, 48007-7021, US

(73) Assignee: Toyota Engineering & Manufacturing North America, Inc., Erlanger, KY (US)

(21) Appl. No.: 11/671,133

(22) Filed: Feb. 5, 2007

Related U.S. Application Data
(60) Provisional application No. 60/765,830, filed on Feb. 7, 2006.

(51) Int. Cl. B60J 5/00

(52) U.S. Cl. 296/146.7

(57) ABSTRACT

An energy absorbing boss for a trim panel that is secured to a body panel on a vehicle includes a generally planar trim panel having an inner surface facing the body panel and an outer surface facing into the vehicle. An energy absorbing boss extends radially from an inner surface of the trim panel, and includes an upper end, a lower end attached to the trim panel, and a wall having a predetermined thickness extending therebetween the upper end and the lower end. A triangular support fin extends radially from a lower portion of the wall, such that a lowermost end of the support fin is attached to the trim panel. Energy from a load applied to the body panel is absorbed by the energy absorbing boss at a predetermined rate.

### CROSS-REFERENCE TO RELATED APPLICATIONS

This application claims priority of U.S. Provisional Patent Application Ser. No. 60/765,830 filed Feb. 7, 2006, which is incorporated herein by reference.

### FIELD OF THE INVENTION

The present invention relates generally to a structure in a motor vehicle. More particularly, it relates to an energy absorbing member for controlling crush characteristics of a structural portion of a vehicle.

### BACKGROUND OF THE INVENTION

Vehicles, and in particular motor vehicles, typically include a plurality of interconnected members that provide shape and strength to the exterior vehicle structure. One example of a structural member is a body panel, such as a door panel, or the like. Body panels are typically made of a metal material, although other material may be utilized. In order to protect a vehicle occupant and provide an aesthetically pleasing appearance within the occupant compartment of the vehicle, a trim panel is typically attached to the body panel. Functional components, such as door handles, or window or mirror controls or speakers or the like may also be positioned on the trim panel or between the trim panel and body panel.

Under certain circumstances, a force may be applied to the body panel, such as the force resulting from the contact of another object with the vehicle. Depending on the degree and direction of the applied force to the body panel, the force may be transferred through the body panel to the trim panel, potentially resulting in movement of the trim panel into the occupant compartment of the vehicle. For example, it is contemplated that a portion of the side structure of the vehicle, including the trim panel, may be pushed into the occupant compartment of the vehicle as a result of a side impact. At the same time, a seated occupant in the vicinity of the side panel may be moving in the direction of the side panel, due to the multiple forces that occur in such a situation. Therefore, federal motor vehicle standards have been established which set forth minimum requirements with regards to occupant compartment integrity. For example, Federal Motor Vehicle Safety Standard (FMVSS) 214 sets forth side impact standards that vehicles must comply with that are sold in the United States. This standard establishes minimum requirements to protect an occupant of the vehicle during an impact, and is determinative of body panel strength, or trim panel strength.

The vehicle body panel and trim panel may incorporate various energy absorption features, in order to mitigate the energy generated due to an impact. An example of an energy absorption feature is a fastener that absorbs an applied force. Another example of an energy absorption feature is a reinforcement member for strengthening the body panel. Still another example of an energy absorption feature is shock absorbing member for absorbing a force. While these energy absorbing features all work well, they do not control the distribution of the applied force in a predetermined manner. Thus, there is a need in the art for an energy absorbing boss structure that is used in conjunction with a trim panel and vehicle body panel, to provide for a controlled absorption of force during an impact.

### SUMMARY OF THE INVENTION

Accordingly, an energy absorbing boss for a trim panel that is secured to a body panel on a vehicle is provided. The trim panel is a generally planar, and has an inner surface facing the body panel and an outer surface facing into the vehicle. An energy absorbing boss extends radially from an inner surface of the trim panel, and includes an upper end, a lower end attached to the trim panel, and a wall having a predetermined thickness extending therebetween the upper end and the lower end. A triangular support fin extends radially from a lower portion of the wall, such that a lowermost end of the support fin is attached to the trim panel. Energy from a load applied to the door panel is absorbed by the energy absorbing boss at a predetermined rate.

One advantage of the present invention is that an energy absorbing boss for a trim panel is provided that absorbs the energy from an applied force in a controlled manner. Another advantage of the present invention is that the energy absorbed by the energy absorbing boss reduces the relative strength of a contact force on an occupant of the vehicle. Still a further advantage of the present invention is that the energy absorbing boss is integral with the trim panel, so it is cost effective to manufacture.

Other objects, features and advantages of the present invention will be readily appreciated as the same becomes better understood after reading the subsequent description when considered in connection with accompanying drawings.

### BRIEF DESCRIPTION OF THE DRAWINGS

FIG. 1 is an elevational view of an inner surface of a trim panel for a motor vehicle, according to the present invention.

FIG. 2 is a partial perspective view of an energy absorbing boss for the trim panel of FIG. 1, according to the present invention.

FIG. 3 is a side elevational view of the energy absorbing boss for the trim panel of FIG. 1, according to the present invention.

FIG. 4 is a partial side view of an interior compartment of a vehicle, prior to the application of an applied force, according to the present invention.

FIG. 5 is a partial side view of the interior compartment of the vehicle of FIG. 4 after the application of the applied force, according to the present invention.

FIG. 6 is a graph illustrating the dimensional relationships of the energy absorbing boss, according to the present invention.

FIG. 7 is a graph illustrating the energy absorbing characteristic of the energy absorbing boss, according to the present invention.

### DETAILED DESCRIPTION OF THE PREFERRED EMBODIMENTS

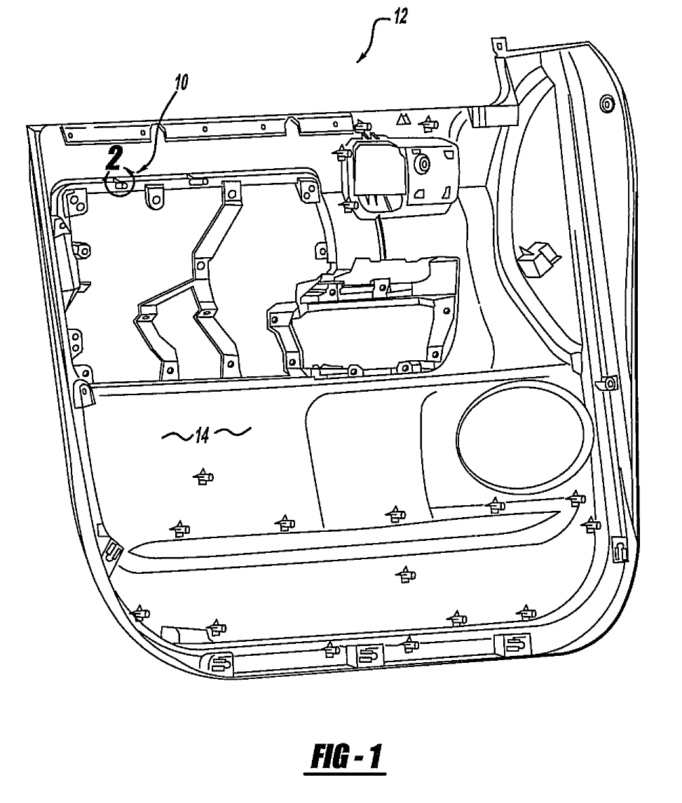

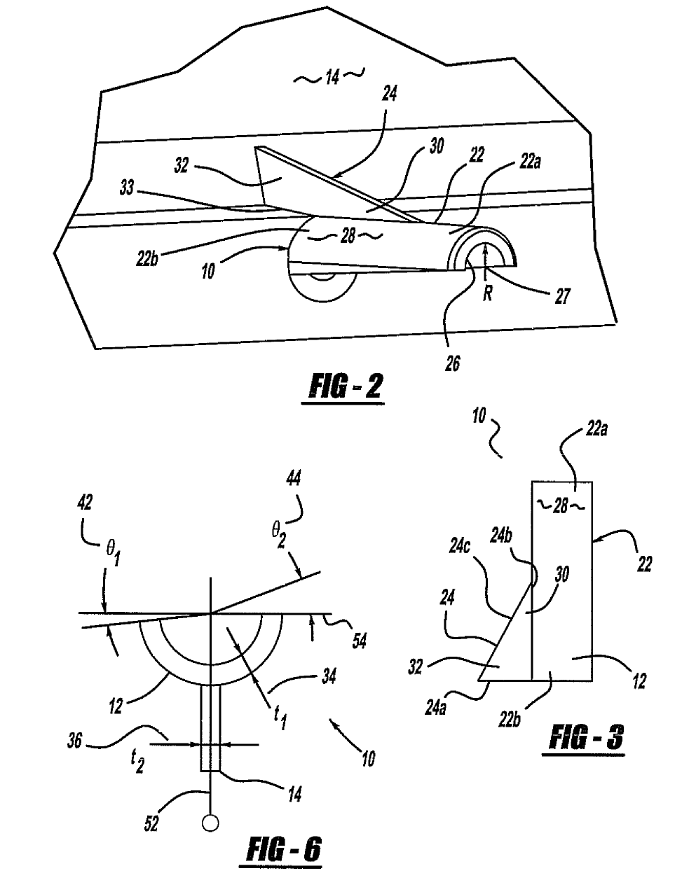

Referring to FIGS. 1-5, an energy absorbing boss 10 for a trim panel 12 associated with a body panel 18 on a vehicle is illustrated. In this example, the body panel 18 is a conventional door panel. At least a portion of the door panel may include an outer panel and an inner panel (not shown). A mechanism, such as a window mechanism, may be disposed between the inner door panel and the outer door panel, or between the door panel and a trim panel, as is understood in the vehicle art.

The trim panel is secured to the body panel using an attachment means, such as a retainer, or fastener, or clip, or hook or the like. The trim panel 12 is a generally planar member, and has an inner surface 14 that faces the body panel 18, and an outer surface 16 that faces the interior of the vehicle. It should be appreciated that the trim panel 12 may be formed from one piece, or multiple sections integrally connected together. Further, the trim panel 12 may include features, such as integrally formed armrest, pocket, or the like. In addition, the trim panel 12 may include an aperture to facilitate attachment thereto of a related mechanism, such as a door handle or window control or door lock of this example. The outer surface 16 of the trim panel facing into the occupant compartment of the vehicle may be decorative in appearance. The trim panel 12 may be formed from a variety of materials, such as plastic or metal or the like. Further, the trim panel 12 may include other features that are conventionally known in the art.

The inner surface 14 of the trim panel 12 includes an integrally formed energy absorbing boss 10. It is contemplated that the trim panel 12 will include a plurality of strategically positioned energy absorbing bosses 10. The energy absorbing boss 10 includes a base member formed by a wall 22 having a predetermined shape. In this example, the base wall 22 is configured as a half cylinder having a predetermined wall height, width and density. An integrally formed channel 26 extends longitudinally through the interior of the base wall 22. The width is defined by a radius R, as shown at 27. A lower end 22b of the base wall 22 is connected to the trim panel 12. An upper end 22a of the base wall 22 is adjacent the body panel 18. It should be appreciated that the upper end 22a of the base wall 22 may nominally be in contact with the body panel 18 during a typical operating condition.

The energy absorbing boss 10 also includes an integrally formed support fin 24 extending longitudinally along an outer surface 28 of the base wall 22. In this example, the support fin 24 is configured as a planar member, having a generally triangular shape. The support fin 24 has a predetermined shape that includes a base length 24a, a height 24b, and a hypotenuse 24c. The support fin has a predetermined thickness. The support fin 24 has a substantially right triangular shape. The upper end 30 of the support fin 24 is oriented towards the upper end 22a of the base wall, while the lower end 32 of the support fin is oriented towards the lower end 22b of the base wall. It should be appreciated that the support fin lower end 32 may extend beyond the base wall lower end, to cooperate with the shape of the trim panel as shown at 33.

It should be understood that the energy absorbing boss 10 may have other configurations, in accordance with the present invention. For example, the base wall 22 may be a C-shaped member, a member formed from two angular projections, a paraboloid member, a conical member, or a cylindrical member, or the like. In addition, the support fin 24 may have another shape, such as curved, or a more complex polygonal shape. Further, it is contemplated that either one of the base wall 22 or support fin 24 may include an additional feature such as an opening or thinned area formed therein or the like, in order to further control the crush characteristics of the energy absorbing boss.

The energy absorbing boss 10 advantageously controls movement of the body panel 18 and trim panel 12, as a result of an applied force or load to the body panel, as shown at 40 in FIGS. 4 and 5. In particular, the selection of various predetermined dimensional relationships associated with the base wall 22 or support fin 24, controls the rate of energy absorption, or crush of the energy absorbing boss upon the application of a load 40. For example, as shown in FIGS. 5 and 6, the thickness of the base wall may be designated as t₁ as shown at 34, and the thickness of the support fin as t₂ as shown at 36. For example, a normal line may be drawn through a cross section of the boss as shown at 52. A perpendicular line may be drawn coplanar with an edge of the wall as shown at 54. The angular relationship θ₁ is defined as the angle between the edge of the wall and the line, as shown at 42, and the angular relationship θ₂ is defined as the angle between the end of the wall and another point, as shown at 44. The application of a force 40 to the upper end 22a of the energy absorbing boss 10 due to an impact to the body panel 18, results in the elastic deformation of the boss 22, and then plastic deformation of the boss 22. As a result of this controlled deformation, the amount of energy transferred to the trim panel 12 and potentially to an occupant 38 of the vehicle, is reduced. In addition, the location, number, orientation and dimensions of energy absorbing bosses 10 disposed on the trim panel 12 can be selected in order to minimize the transfer of energy through the trim panel 12 as a result of an applied load 40 to the body panel.

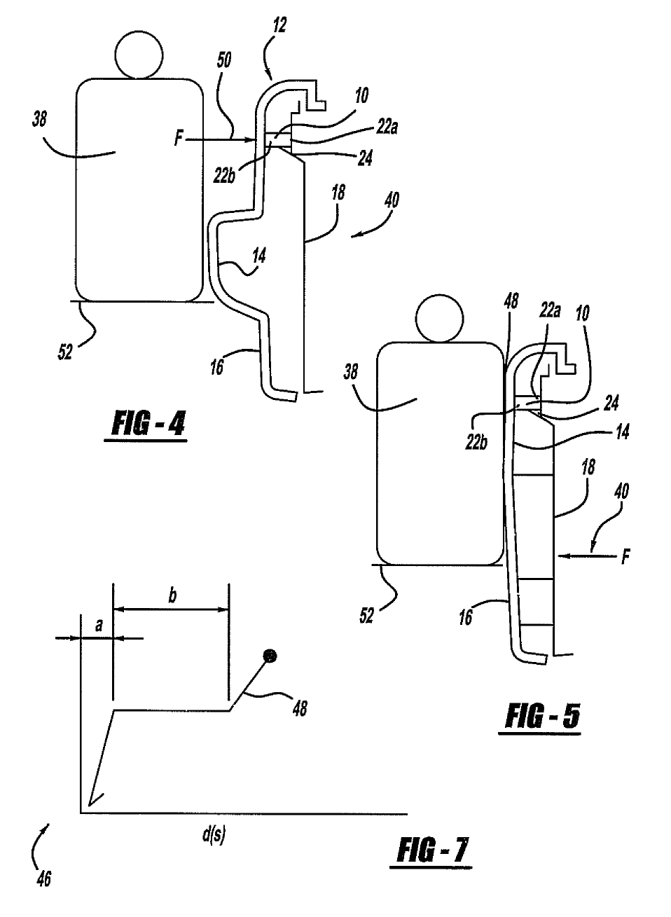

FIG. 7 further illustrates optimization of the energy absorption characteristics of the energy absorbing boss using a graph 46 showing deformation of the boss as a function of applied force 40. As will be seen, the boss 10 can be configured so as to provide for an initial elastic deformation as shown at a, which is followed by a plastic deformation as shown at b. As can be appreciated from the graph of FIG. 7, the energy absorbing boss 10 operatively absorbs a predetermined amount of force during deformation. The deformation profile, and hence the force absorbing properties of the boss, may be readily controlled by adjusting the previously described geometric parameters of the base wall 22 and support fin 24.

As is further shown in FIG. 4, a representative vehicle occupant 38, such as a crash test dummy, is positioned on a seat 52. The vehicle is subjected to a force F 40 or load is applied to the body panel 18, and the energy absorbing boss 10 undergoes elastic deformation and then plastic deformation. As a result, the amount of energy transferred through the trim panel is reduced, with a similar reduction in the amount of energy transferred to the occupant of a seat. FIG. 5 shows the result of the energy transfer and panel deformation at 48. The occupant of the vehicle may also be moving towards the trim panel with a predetermined force, as shown at 50. The energy absorbing boss reduces any resulting force from this secondary impact.

The present invention has been described in an illustrative manner. It is to be understood that the terminology which has been used is intended to be in the nature of words of description rather than of limitation.

Many modifications and variations of the present invention are possible in light of the above teachings. Therefore, within the scope of the appended claims, the present invention may be practiced other than as specifically described.

1. An energy absorbing boss for a trim panel that is secured to a body panel on a vehicle comprising:
a generally planar trim panel having an inner surface facing the body panel and an outer surface facing into the vehicle;
an energy absorbing boss extending radially from an inner surface of said trim panel, wherein said energy absorbing boss includes an upper end, a lower end attached to the trim panel, and a wall having a predetermined thickness extending therebetween said upper end and said lower end, and a triangular support fin extending radially from a lower portion of said wall, such that a lowermost end of said support fin is attached to said trim panel, so that energy from a load applied to the body panel is absorbed by said energy absorbing boss at a predetermined rate.

2. The energy absorbing boss as set forth in claim 1 wherein said wall is shaped as a half cylinder, and a channel extends longitudinally therethrough a central portion of said half cylinder.

3. The energy absorbing boss as set forth in claim 1 wherein the predetermined thickness of said wall is uniform throughout.

4. The energy absorbing boss as set forth in claim 1 wherein said support fin has a triangular shape, and the lowermost end of said support fin is attached to the inner surface of said trim panel.

5. The energy absorbing boss as set forth in claim 4 wherein said support fin has a right triangular shape.

6. The energy absorbing boss as set forth in claim 1 wherein an applied force to the body panel initiates an elastic deformation beginning with an upper end of the boss followed by plastic deformation of the boss.

7. An energy absorbing boss for a trim panel that is secured to a body panel on a vehicle comprising:
a generally planar trim panel having an inner surface facing the body panel and an outer surface facing into the vehicle;
an energy absorbing boss extending radially from an inner surface of said trim panel, wherein said energy absorbing boss includes an upper end, a lower end attached to the trim panel, and a wall having a predetermined thickness extending therebetween said upper end and said lower end, wherein said wall is shaped as a half cylinder, and a channel extends longitudinally therethrough a central portion of said half cylinder and a triangular support fin extending radially from a lower portion of said wall, such that a lowermost end of said support fin is attached to said trim panel, so that energy from a load applied to the body panel initiates an elastic deformation at a predetermined rate beginning with an upper end of the boss followed by plastic deformation at a predetermined rate of the boss.

8. The energy absorbing boss as set forth in claim 7 wherein the predetermined thickness of said wall is uniform throughout.

9. The energy absorbing boss as set forth in claim 1 wherein said support fin has a triangular shape, and the lowermost end of said support fin is attached to the inner surface of said trim panel.

10. The energy absorbing boss as set forth in claim 9 wherein said support fin has a right triangular shape.

11. An energy absorbing boss for a trim panel that is secured to a body panel on a vehicle comprising:
a generally planar trim panel having an inner surface facing the body panel and an outer surface facing into the vehicle;
an energy absorbing boss extending radially from an inner surface of said trim panel having an upper end and a lower end attached to the trim panel, a wall shaped as a half cylinder and having a predetermined thickness extends therebetween said upper end and said lower end, a channel extends longitudinally therethrough a central portion of said half cylinder, and a triangular support fin extends radially from a lower portion of said wall, wherein said support fin has a right triangular shape, and the lowermost end of said support fin is attached to the inner surface of said trim panel so that energy from a load applied to the body panel initiates elastic deformation at a predetermined rate beginning with an upper end of the boss followed by plastic deformation at a predetermined rate of the boss.

12. The energy absorbing boss as set forth in claim 7 wherein the predetermined thickness of said wall is uniform throughout.
